(19) United States
(12) Patent Application Publication
(10) Pub. No.: US 2003/0188475 A1
(43) Pub. Date: Oct. 9, 2003

(54) Dynamic fuel processor with controlled declining temperatures

(76) Inventors: Shabbir Ahmed, Naperville, IL (US); Sheldon H. Lee, Willowbrook, IL (US); Steven G. Calderone, Arlington Heights, IL (US); Richard L. Kao, Northbrook, IL (US); Elias H. Camara, Clarendon Hills, IL (US); Steven A. Lottes, Naperville, IL (US); Michael Krumpelt, Naperville, IL (US); Todd L. Harvey, Arlington Heights, IL (US)

Correspondence Address: Welsh & Katz, Ltd., Thomas W. Tolpin, 22nd Floor, 120 South Riverside Plaza, Chicago, IL, 60606, US

(21) Appl. No.: 10/112,684

(22) Filed: Mar. 29, 2002

(51) Int. Cl. B01J 8/04

(52) U.S. Cl. 44/639

(57) ABSTRACT

A dynamic, compact, lightweight fuel processor that is capable of converting carbonaceous fuels to hydrogen rich gases suitable for all types of fuel cells or chemical processing applications. The fuel processor and process are based on the autothermal hydrodesulfurizing reforming reaction, followed by clean up of byproduct sulfur-containing gases and carbon monoxide that poison the fuel cell electrocatalyst. The fuel processor uses proprietary catalysts and hardware designs that enable the conversion in an energy efficient manner while maintaining desirable performance characteristics such as rapid start-stop and fast response to load change capabilities.

### FIELD OF THE INVENTION

This invention relates to a dynamic, compact and lightweight fuel processor that is capable of converting carbonaceous fuels to hydrogen rich gases suitable for all types of fuel cells or chemical processing applications. Proprietary catalysts and hardware designs are used to enable the fuel processor to have high energy efficiency while maintaining desirable performance characteristics.

### BACKGROUND OF THE INVENTION

Fuel cells are an environmentally clean, quiet, and highly efficient method for generating electricity and heat from natural gas and other fuels. Fuel cells are being developed for portable, residential, commercial, industrial, transportation and other power generations. They are vastly different from other power generation systems. A fuel cell is an electrochemical device that converts the chemical energy of a fuel directly to usable pollution-free energy—electricity and heat—without combustion.

Individual fuel cells typically are stacked with bipolar separator plates separating the anode electrode of one fuel cell from the cathode electrode of an adjacent fuel cell to produce fuel cell stacks. These fuel cell stacks make the fuel cells operate at high efficiency, regardless of size and load. Distributed power generation from fuel cells reduces the capital investment and further improves the overall conversion efficiency of fuel to end use electricity by reducing transmission losses. Substantial advancements have been made during the past several years in fuel cells. Increased interest in the commercialization of polymer electrolyte membrane (PEM) fuel cells, in particular, has resulted from recent advances in fuel cell technology, such as more economical bipolar separator plates and the 100-fold reduction in the platinum content of the electrodes.

Ideally, PEM fuel cells operate with hydrogen. In the absence of a viable hydrogen storage option or a near-term hydrogen-refueling infrastructure, it is necessary to convert available fuels, typically CₙHₘ and CₙHₘOₚ, collectively referred to herein as carbonaceous fuels, with a fuel processor into a hydrogen rich gases suitable for use in fuel cells. The choice of fuel for fuel cell systems will be determined by the nature of the application and the fuel available at the point of use. In transportation applications, it may be gasoline, diesel, methanol or ethanol. In stationary systems, it is likely to be natural gas or liquefied petroleum gas. In certain niche markets, the fuel could be ethanol, butane or even biomass-derived materials. In all cases, reforming of the fuel is necessary to produce a hydrogen rich gas.

Steam reforming is probably the most common method for producing hydrogen in the chemical process industry. In this process, steam reacts with the carbonaceous fuels such as natural gas, in the presence of a catalyst (often Ni based) to produce hydrogen, carbon monoxide and carbon dioxide. In addition to natural gas, steam reformers can be used on light carbonaceous fuels such as methanol, ethanol, propane and butane. In fact, with a special catalyst, steam reformers can also reform naphtha. These reformers are well suited for long periods of steady-state operation, and can deliver relatively high concentrations of hydrogen (>70% on a dry basis). The carbon monoxide and carbon dioxide are removed from the reformate gas stream by a variety of reactions and scrubbing techniques such as water gas shift (WGS) reaction, methanation, CO₂ absorption in amine solutions, and pressure swing adsorption.

CnHmOp+(2n−p)H₂O [symbol] (n−y)CO₂+(2n−p+m/2−y)H₂+yCO+yH₂O

Where y is the number of moles of CO₂ that reacts with H₂ to produce CO and H₂O due to the WGS reaction.

The primary steam reforming reaction is strongly endothermic and needs a significant heat source. Heat transfer, rather than the reaction kinetics, typically limits reactor designs. Consequently, these reactors are designed to promote heat exchange and tend to be heavy and large. The indirect heat transfer (across a wall) makes conventional steam reformers less attractive for the rapid start-stop, dynamic response and for being capable of operating at varying loads needed in home, portable and transportation applications. Often the residual fuel exiting the fuel cell is burned to supply this heat requirement. Fuels are typically steam reformed at temperatures of 760 to 980° C. (1400 to 1800° F.).

For the steam reforming of methane, i.e. n=1, m=4 and p=0:

CH₄+2H₂O [symbol] (1−y)CO₂+(4−y)H₂+yCO+yH₂O

And when

y=0

CH₄+2H₂O [symbol] CO₂+4H₂

y=0.5

CH₄+2H₂O [symbol] 0.5CO₂+3.5H₂+0.5CO+0.5H₂O

y=1

CH₄+H₂O [symbol] CO+3H₂

And the reformate gas has a composition of:

| | mol %, dry | | |
|---|---|---|---|
| Steam Reformer Products | y = 0 | y = 0.5 | y = 1 |
| H₂ | 80 | 78 | 75 |
| CO | — | 11 | 25 |
| CO₂ | 20 | 11 | — |
| TOTAL | 100 | 100 | 100 |

The difference of the above two equations when y=0 and y=1 is the WGS reaction:

CO+H₂O [symbol] CO₂+H₂

An alternative to steam reforming is partial oxidation reforming. In such reformers, some of the fuel is combusted directly in the process chamber with a sub-stoichiometric amount of oxidant such as air, enriched air or pure oxygen, eliminating the steam reforming heat transfer limitation and allowing much faster start-stop, and dynamic responses to load changes. Partial oxidation reforming with air is represented by the reaction:

CnHmOp+n(O₂+3.76N₂) [symbol] (n−y)CO₂+(m/2−p−y)H₂+yCO+(p+y)H₂O+3.76nN₂

However, partial oxidation reformers operate at a temperature in the range of 1100-1300° C. when a catalyst is present, because the gas phase oxidation of hydrocarbons requires such a high temperature. There are substantial disadvantages to operating at these temperatures. First, heating the reaction mixture to 1300° C. consumes significant amounts of energy, which reduces the energy efficiency. Second, the materials of construction to tolerate these high temperatures are expensive and difficult to fabricate. All commercial partial oxidation reformers employ non-catalytic partial oxidation of the feed stream by oxygen in the presence of steam with flame temperatures of approximately 1300 to 1500° C.

For partial oxidation reforming of methane with air, i.e. n=1, m=4, p=0:

CH₄+O₂+3.76N₂ [symbol] (1−y) CO₂+(2−y)H2+yCO+yH₂O+3.76 N₂

And when

y=0

CH₄+O₂+3.76N₂ [symbol] CO₂+2H₂+3.76N₂

y=0.5

CH₄+O₂+3.76N₂ [symbol] 0.5CO₂+1.5H₂+0.5CO+0.5H₂O+3.76N₂

y=1

CH₄+O₂+3.76N₂ [symbol] CO+H₂+H₂O+3.76 N₂

And the reformate gas has a composition of:

| | mol %, dry | | |
|---|---|---|---|
| Partial Oxidation Reformer Products | y = 0 | y = 0.5 | y = 1 |
| H₂ | 30 | 24 | 17 |
| CO | — | 8 | 17 |
| CO₂ | 15 | 8 | — |
| N₂ | 55 | 60 | 66 |
| TOTAL | 100 | 100 | 100 |

Autothermal reformers combine the heat effects of the partial oxidation and steam reforming reactions by feeding the fuel, water and oxidant such as air together into the reformer. This process is carried out in the presence of a catalyst, which controls the reaction pathways and thereby determines the relative extents of the oxidation and steam reforming reactions. The presence of steam and the use of an appropriate catalyst provide benefits, such as lower temperature operation and greater product selectivity to favor the formation of H₂ and CO₂, while inhibiting the formation of coke.

The initial oxidation reaction results in heat generation and high temperatures. The heat generated from the oxidation reaction is then used to steam-reform the remaining fuels by injecting an appropriate amount of steam into this gas mixture. The oxidation step in air may be conducted with or without a catalyst.

CnHmOp+χ(O₂+3.76N₂)+(2n−2χ−p)H₂O [symbol] (n−y)CO₂+(2n−2χ−p+m/2−y)H₂+yCO+yH₂O+3.76χN₂

Where χ is the oxygen-to-fuel molar ratio and y is the number of moles of CO₂ that reacts with H₂ to produce CO and H₂O due to the WGS reaction.

This χ ratio is a very important parameter because it determines:

the amount of water required to convert the carbon to carbon oxides,

the hydrogen yield,

the concentration of hydrogen in the products, and

the heat of reaction.

This reaction is endothermic at low values of χ, and exothermic at high values of χ. At an intermediate value (χₒ), the heat of reaction is zero.

For autothermal reforming of methane with air, i.e. n=1, m=4, p=0:

CH₄+χ(O₂+3.76N₂)+(2−2χ)H₂O [symbol] (1−y)CO₂+(4−2χ−y)H₂+yCO+yH₂O+3.76χN₂

When χ=0.5 and

y=0

CH₄+0.5(O₂+3.76N₂)+H₂O [symbol] CO₂+3H₂+1.88N₂

y=0.5

CH₄+0.5(O₂+3.76N₂)+H₂O [symbol] 0.5CO₂+2.5H₂+0.5CO+1.88N₂+0.5H₂O

y=1

CH₄+0.5(O₂+3.76N₂)+H₂O [symbol] 2H₂+CO+1.88N₂+H₂O

And the reformate gas has a composition of:

| | mol %, dry, _{χ} = 0.5 | | |
|---|---|---|---|
| Autothermal Reformer Products | y = 0 | y = 0.5 | y = 1 |
| H₂ | 51.0 | 46.5 | 41.0 |
| CO | — | 9.3 | 20.5 |
| CO₂ | 17.0 | 9.3 | — |
| N₂ | 32.0 | 34.9 | 38.5 |
| TOTAL | 100.0 | 100.0 | 100.0 |

Therefore, the steam reforming gives the highest H₂ yield, and the partial oxidation reforming gives the lowest. Regardless of the type of reformer, the initial product invariably contains carbon monoxide, i.e. y>0. The bulk of the CO can be converted to additional hydrogen via the WGS reaction. Hydrogen formation is enhanced by low temperatures, but is unaffected by pressure. Shift reactors can lower the CO level to about 0.5 to 2 mol %.

Since the CO acts as a severe PEM fuel cell electrocatalyst poison, a CO clean-up system is usually required right ahead of the fuel cell stacks. The final CO contaminant reduction to <10 ppm is optimally approached using a catalytic preferential oxidation (PROX) step:

CO+½O₂⇄CO₂

In this invention, our proprietary catalyst (U.S. patent application (May 18, 2002) “Autothermal Hydrodesulfurizing Reforming Catalyst” Ser. No. 09/860,850) is used for the autothermal reforming of sulfur-containing carbonaceous fuels into hydrogen rich gases without any prior desulfurization.

The catalyst's performance is not poisoned or degraded by sulfur impurities in the fuels. Sulfur impurities react in the autothermal reformer and are converted to hydrogen sulfide, hydrogen and carbon oxides. The hydrogen sulfide can then be removed by a zinc oxide bed at lower temperature range after the reformer. Autothermal hydrodesulfurizing reformer (AHR) is used here to present the combination of autothermal reforming and hydrodesulfurizing reactions in one reformer.

### BRIEF SUMMARY OF THE INVENTION

The present invention seeks to provide an economical, efficient and compactly configured dynamic fuel processor for converting carbonaceous fuels into hydrogen rich gases for all types of fuel cells or chemical processing applications.

As shown one embodiment of FIG. 1, an evaporator/preheater, AHR, zinc oxide bed and WGS reactor can be wrapped around each other in a concentric vessel design for simplified thermal management.

It is an object of this invention to use a proprietary AHR catalyst for low temperature (about 600 to 800° C.) reforming of sulfur-containing carbonaceous fuels without any prior desulfurization. Desirably, the catalyst's performance is not poisoned or degraded by sulfur impurities in the fuels.

It is another object of this invention to adopt improved WGS catalysts, which enable the use of a single-stage WGS reactor, wherein the catalyst is much more thermally rugged than copper-zinc oxide catalyst. These catalysts are active at about 200 to 400° C., and appears to be very attractive for fuel cell applications because it can tolerate both oxidizing and reducing environments, as well as temperature excursions.

It is a further object of this invention to use a catalytic PROX unit for the final CO contaminant reduction to less than 10 ppm levels required by the PEM fuel cell stacks.

It is yet still a further object of this invention to enable the dynamic fuel processor having desirable performance characteristics such as rapid start-stop and fast response to load change capabilities.

It is yet still another object of this invention to use computational fluid dynamics as a design tool to optimize engineering mixing zone designs for the dynamic fuel processor.

These and other objects of this invention are addressed by a system having been configured so that the fuel-water-oxidant mixture first enters through a vaporizer/preheater and then flows into an autothermal hydrodesulfurizing reforming section. The reformed gas can then flow through a zinc oxide bed to capture the reduced sulfur components. Appropriate water gas shifting can be conducted to lower the CO level and enhance the hydrogen formation. The gas can flow through a PROX unit to bring the CO effluent levels down to appropriate levels.

In one form, a dynamic fuel processor is provided for converting carbonaceous fuels into hydrogen rich gases for fueling many types of fuel cells or chemical processing applications (chemical processors). The dynamic fuel processor can comprise a vaporizer and preheater for vaporizing liquid fuels and water and for preheating feeds by transferring sensible heat from the reformate gas. The dynamic fuel processor can include a feed mixer to provide reactant mixing. The feed mixer can comprise a static mixer, opposite jets, opposed annular jets, etc. An Autothermal Hydrodesulfurizing Reformer (AHR) can be provided to combine the heat affects of partial oxidation, steam reforming reactions, preheated and heat losses by feeding fuel, water and an oxidant, such as air or an oxygen-containing gas, over a sulfur tolerant three part catalyst to yield a hydrogen rich reformate gas. A zinc oxide sulfur trap can also be provided to remove sulfur impurities at low temperatures, such as from 250 to 400° C. A water gas shift (WGS) reactor can be provided to convert carbon monoxide (CO) and water in a reformate gas to carbon dioxide (CO₂) and produce additional hydrogen by a WGS reaction. A steam generator can further be provided to vaporize and superheat water feed to a WGS boiler coil. A preferential oxidation (PROX) reactor can also be provided to reduce carbon monoxide (CO) levels in the reformats gas.

In another form, a fuel processor is provided to convert carbonaceous fuels into hydrogen rich gases for use with fuel cells or chemical processing applications. The novel fuel processor comprises a set of three cylinders positioned substantially concentrically to each other to define an autothermal hydrodesulfurizing reforming reaction zone, a sulfur reaction removal zone, and water gas shift (WGS) reaction zone. These cylinders can comprise an inner cylinder providing an autothermal hydrodesulfurizing reformer (AHR), an outer cylinder positioned outwardly of the inner cylinder, and an intermediate cylinder positioned between the inner cylinder and the outer cylinder. The AHR can comprise a dome which can define a diffuser zone. The AHR can also comprise a fuel tube in communication with the diffuser zone. A fuel injector can be provided to feed carbonaceous fuel into the fuel tube. One or more oxygen-containing gas injectors can also be provided to feed air or another oxygen-containing gas into the fuel tube along with the fuel. One or more water injectors can be provided to feed and mix steam and/or water with the fuel and oxygen-containing gas in the fuel tube. Desirably, an AHR catalyst is positioned below the dome. In the preferred form, the AHR catalyst comprises a dehydrogenation portion, an oxidation portion, and a hydrodesulfurizing portion.

The hydrogenation portion of the AHR catalyst can comprise a metal and metal alloy from a Group VIII transition metals and/or mixtures thereof. The oxidation portion of the AHR catalyst can comprise a ceramic oxide powder and dopant, such as rare earth metal, alkaline earth metals, alkali metals and/or mixtures thereof. The hydrodesulfurization portion of AHR catalyst can comprise one or more of the following: Group IV rare earth metal sulfides, Group IV rare earth metal sulfates, as well as their substoichimetric metals. The ceramic oxide powder can comprise a material such as ZrO₂, CeO₂, Bi₂O₃, BiVO₄, LaGdO₃ and/or mixtures thereof.

In a further form, the inventive fuel processor comprises a set of vessels having substantially upright concentric annular walls. The vessels can comprise an inner vessel, an outer vessel, and an intermediate vessel which is positioned between the inner vessel and the outer vessel. The outer vessel can comprise an autothermal hydrodesulfurizing reformer (AHR) with an autothermal hydrodesulfurizing reforming reaction zone containing a bed of AHR catalyst as indicated above. The inner vessel can comprise a dome providing a diffuser zone which is positioned above the autothermal hydrodesulfurizing reforming reaction zone. The AHR can also comprise a fuel tube in communication with the diffuser zone. The AHR can further have injectors for feeding a feed mixture of carbonaceous fuel, an oxidant such as air or an oxygen-containing gas, and water (liquid and/or steam), through the fuel tube into the diffuser zone. Desirably, the AHR catalyst reforms the feed mixture to form a hydrogen-rich reformate gas in the autothermal hydrodesulfurizing reforming reaction zone.

An annulus comprising an intermediate annular vaporizer and preheater zone can be positioned between the inner vessel and outer vessel so as to communicate with the autothermal hydrodesulfurizing reforming reaction zone to receive and cool the hot reformate gas from the autothermal hydrodesulfurizing reforming reaction zone. The intermediate annular vaporizer and preheater zone can contain a preheat coil to receive sensible heat form the reformate gas to heat at least some of the oxidant and/or steam.

An annular sulfur removal zone can be positioned between the intermediate vessel and the outer vessel so as to communicate with the intermediate annular vaporizer and preheater zone to receive the reformate gas from the intermediate annular vaporizer and preheater zone. Advantageously, the annular sulfur removal zone contains a bed of sulfur-removing catalyst to remove hydrogen sulfide from the reformate gas.

A water gas shift (WGS) reactor can comprise an outer annular WGS reaction zone which is positioned below and communicates with the annular sulfur removing zone at a location between the intermediate vessel and the outer vessel. The WGS reactor can contain a bed of WGS catalyst to remove carbon monoxide (CO) and carbon dioxide (CO₂) from the reformate gas after the hydrosulfide has been removed from the reformate gas in the sulfur removal zone. The WGS reactor can have a boiler coil to heat at least some of the water. The fuel processor can also have an outlet positioned below the inner vessel and the intermediate vessel so as to communicate with the WGS reaction zone to discharge reformate gas after the carbon monoxide (CO) and carbon dioxide (CO₂) have been removed from the reformate gas in the WGS reaction zone.

A more detailed explanation of the invention is provided in the following description and appended claims taken in conjunction with the accompanying drawings.

### BRIEF DESCRIPTION OF THE DRAWINGS

FIG. 1 is a diagram of an advanced dynamic fuel processor in accordance with principles of the present invention;

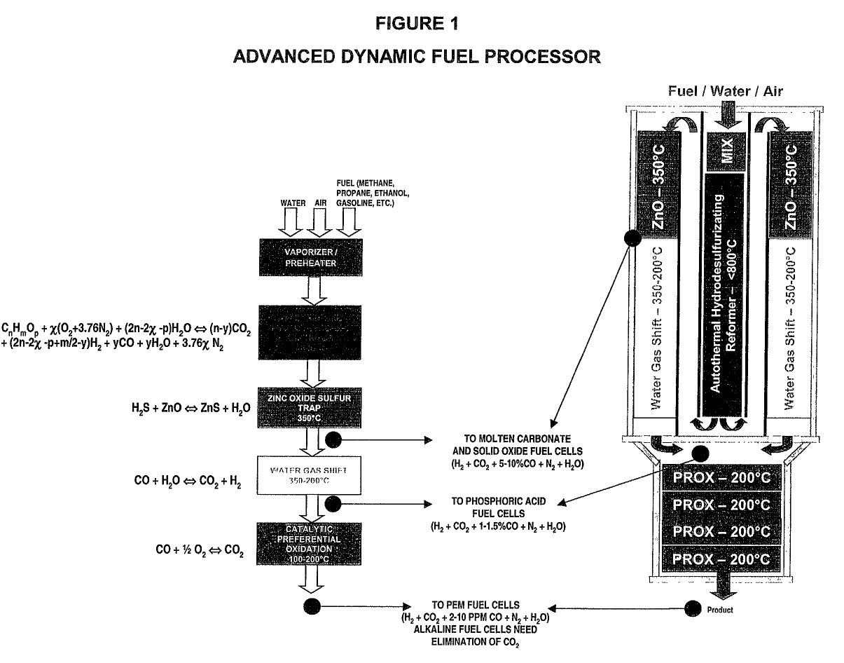

FIG. 2 is a diagram of a portion of a dynamic fuel processor with opposed jets in accordance with principles of the present invention;

FIG. 3 is a diagram of another dynamic fuel processor with a static mixer in accordance with principles of the present invention;

FIG. 4 is a diagram of a further dynamic fuel processor with opposed annular jets in accordance with principles of the present invention;

FIG. 5 are diagrams of grids for computational fluid dynamics (CFD) analysis of mixing geometry design;

FIG. 6 are grid mesh outlines for two (2) and three (3) stages static mixers;

FIG. 7 is a chart illustrating the fuel air mass equivalence ratio deviation evolution for static mixer cases;

FIG. 8 is a diagram of spiral ramp, misaligned opposed jets, and many jets;

FIG. 9 are diagrams illustrating changes to equivalence ratio transversing through two (2) stage static mixer;

FIG. 10 are diagrams illustrating changes to equivalence ratio transversing through three (3) stage static mixer;

FIG. 11 are diagrams illustrating mixing of fuels/air steams for opposed annular jets;

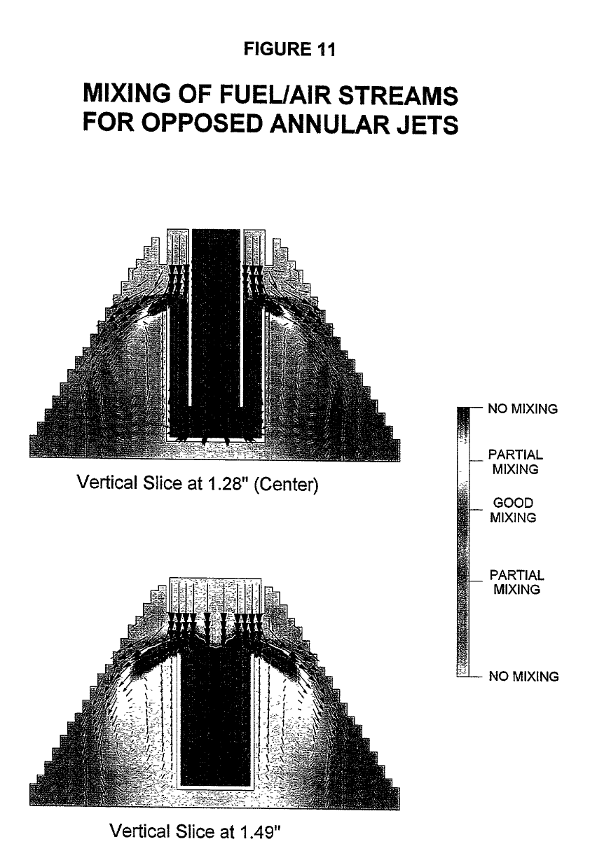

FIG. 12 are charts illustrating temperature profiles of reformate gas, air, and steam along the flowpath of the dynamic fuel processor;

FIG. 13 is a chart illustrating input flow rate changes and water feed management during fuel processor load changes; and

FIG. 14 is a chart illustrating power generation and gas product composition for hydrogen (H₂), carbon dioxide (CO₂) and carbon monoxide (CO) versus fuel processor load changes.

### DETAILED DESCRIPTION OF THE INVENTION

The following is a detailed description and explanation of the preferred embodiments of the invention along with some examples thereof.

Sulfur impurities in carbonaceous fuels such as gasoline, diesel, or natural gas, cause major problems for reforming these fuels to hydrogen rich gases for use in fuel cell power generating systems or chemical processing applications. The sulfur impurities poison the reforming catalysts, as well as other catalysts in the processing stream and catalysts in the fuel cells. The poisoning is generally due to adsorption of sulfur to the active metal catalyst sites. In addition, sulfur impurities increase the coking seen in the reforming catalysts, accelerating a second mechanism for degradation of the catalysts. In order to get a hydrogen rich gas, we must first desulfurize the carbonaceous fuels. This is generally done with hydrodesulfurization, which consumes some of the hydrogen produced. Adsorption processes are other alternatives but are generally less effective than hydrodeulsufirization due to the complex nature of the sulfur impurities in diesel and gasoline fuels. The sulfur is in the form of thiols, thiophenes, and benzothiophenes. The organic functions make it difficult to adsorb the sulfur containing species preferentially.

In accordance with the present invention, the sulfur laden carbonaceous fuels are reformed over our improved sulfur tolerant and coking resistant proprietary catalyst prior to the sulfur removal. The sulfur impurities are cracked or reformed to H₂S, CO₂ and H₂ in the AHR. The H₂S can then be preferentially adsorbed on a zinc oxide bed after the reformer. This will increase the overall energy efficiency of the fuel processor by eliminating the hydrodesulfurization or the sulfur adsorption step prior to the reformer. The bulk of CO in the reformate gas exiting the zinc oxide bed can then be converted to additional hydrogen via the WGS reaction.

The shift conversion is often performed in two or more stages when CO levels are high. A first high temperature stage allows high reaction rates, while a low temperature converter allows for a higher conversion. Excess steam is also utilized to enhance the CO conversion. A single-stage shift reactor can convert 80 to 95% of the CO. The WGS reaction is mildly exothermic, so multiple stage systems need interstage heat exchangers. Hydrogen formation is enhanced by low temperatures, but is unaffected by pressure. Shift reactors can lower the CO level to about 0.5 to 2 mol %.

In the chemical process industry, the shift reaction is conducted at two distinct temperatures. The high-temperature shift (HTS) is carried out at 350 to 450° C., using an Fe—Cr catalyst. The low-temperature shift (LTS) is carried out at 160 to 250° C. with the aid of a Cu—Zn catalyst.

The commercial HTS and LTS catalysts require activation by careful pre-reduction in situ and, once activated, lose their activity very rapidly if they are exposed to air. Moreover, the HTS catalyst is inactive at temperatures below 300° C., while the LTS catalyst degrades if heated to temperatures above 250° C.

In this invention we use a single stage WGS reactor loaded with our alternative proprietary precious metal, non-pyrophoric Pt/mixed oxide/alumina WGS catalyst working at low to medium temperatures which eliminates the need for one additional WGS reactor and the interstage heat exchanger as currently practiced. As opposed to copper/zinc oxide catalyst, this catalyst does not have to be reduced in situ, it does not lose activity upon exposure to air at 21° C. to 550° C., and it is active over the 200 to 400° C. temperature range.

This catalyst can reduce the exit CO concentration to about 1 mol % (dry basis) from a simulated inlet reformate gas consisting of 10 mol % CO, 10 mol % CO₂, 34 mol % H₂, 33 mol % N₂, and 13 mol % H₂O (wet basis), and less than 1 mol % exit CO (dry basis) from an actual inlet diesel reformatted gas at 230 to 300° C. In addition, the estimates based on isothermal kinetic data show that this catalyst has the potential to reduce WGS catalyst volume to 68% of that of the commercial Fe/Cr—Cu/ZnO combination.

We have also developed a non-precious metal, non-pyrophoric WGS catalyst in order to bring the fuel processor cost down. The newly developed Cu/oxide WGS catalyst was identified to have excellent activity from 180 to 400° C. and is capable of reducing the size, volume and weight of WGS reactor by 87%. Besides, no methane is formed in the WGS reactor up to 400° C.

The final CO contaminant reduction to less than 10 ppm levels required by the PEM fuel cell stacks is optimally approached using a catalytic PROX step. A key design feature of the PROX reactor is the use of an easily replaceable catalyst cartridge that can accommodate catalysts in the form of monoliths, pellets, foams, and screens. Another key design feature is the incorporation of a heat exchanger insert that facilitates quick heat exchange for interstage cooling.

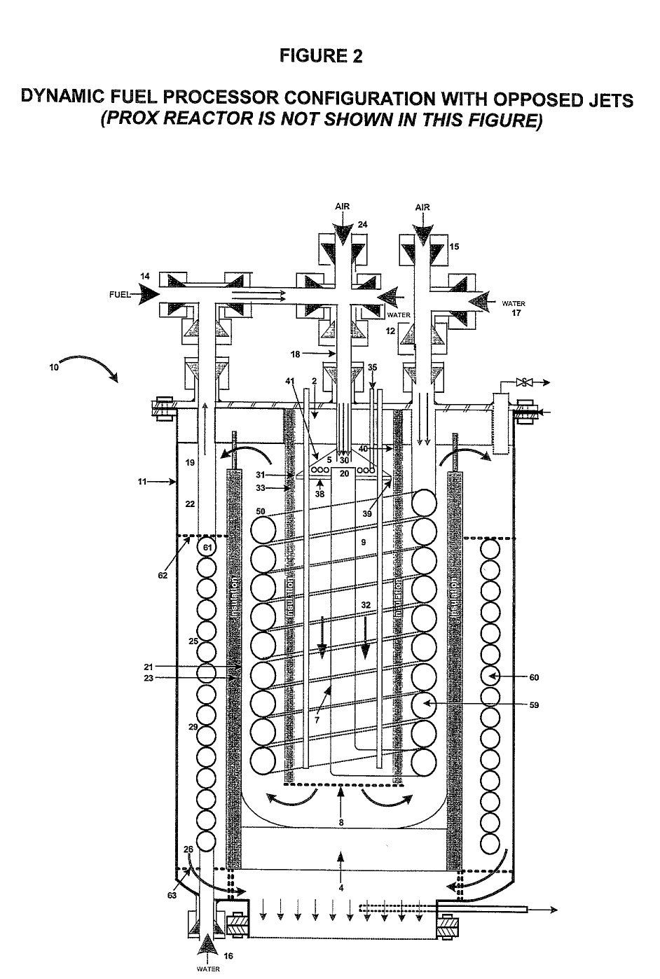

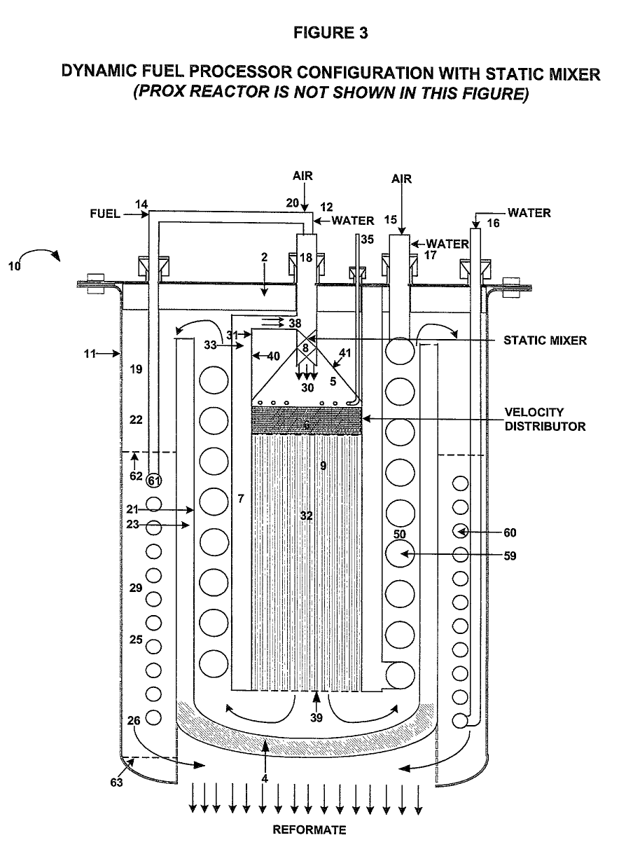

One embodiment of this invention is shown in FIG. 2. Dynamic fuel processor 10 consists of three concentric cylinders 11, 21 and 31 designed to optimize temperature control and thermal integration of the autothermal hydrodesulfurizing reforming reaction zone 32 with the subsequent sulfur removal reaction zone 22 and the WGS reaction zone 25. The fuel processor 10 has insulating slabs 2 and 4 at its axial ends. Inside the fuel processor 10, layers of insulation 23 and 33 separate the three concentric cylinders. The inner cylinder 31 extending substantially the height of the outer cylinder 11 is served as the AHR. AHR has fuel inlet 14, air/O₂ inlets 15 and 24, and steam/water inlets 12, 16 and 17 (FIGS. 2 and 3). Steam/water feed streams entered from inlets 12 and 16 are mixed with fuel and air/O₂ supplies as it enters the fuel inlet tube 18 and exits the fuel tube outlet 30 to the top of diffuser zone 5 under the dome 41. The other steam/water feed stream entered from inlet 17 is mixed with air/O₂ supply as it enters the air preheat coil 59 and exits at air center tube outlet 20 to the top diffuser zone 5 where catalyst 9 comprising a dehydrogenation portion, an oxidation portion, and a hydrodesulfurization portion is packed around an air center tube 7 all the way to the perforated plate 8 at the bottom of the AHR. The air center tube 7 is held in the center position by four 90 degrees apart steel bars 38 welded outside the tube at the tube outlet 20 but having a small clearance between the ends 39 of the bars 38 and the inner surface 40 of cylinder 31. The ends 39 of the bars 38 are further welded to the dome 41, which is again welded to the fuel inlet tube 18 to hold the fuel inlet tube outlet 30 exactly concentrically, but opposed to the air center tube outlet 20. Thus the air center tube 7 and fuel inlet tube 18 are connected as one union, which is free to move vertically up and down to compensate thermal expansion and contraction.

In another embodiment of this invention is shown in FIG. 3. Dynamic fuel processor 10 consists of three concentric cylinders 11, 21 and 31 designed to optimize temperature control and thermal integration of the autothermal hydrodesulfurizing reforming reaction zone 32 with the subsequent sulfur removal reaction zone 22 and the WGS reaction zone 25. The fuel processor 10 has insulating slabs 2 and 4 at its axial ends. Inside the fuel processor 10, layers of insulation 23 and 33 such as zircar, separate the three concentric cylinders. The inner cylinder 31 extending substantially the height of the outer cylinder 11 is served as the AHR. AHR has fuel inlet 14, air/O₂ inlets 15 and 20, and steam/water inlets 12, 16 and 17. Steam/water feed streams entered from inlets 12 and 16 are mixed with fuel supply as it enters the fuel inlet tube 18. Air/O₂ supply can also be fed from inlet 20 into the fuel inlet tube 18 to control the AHR temperature. The other steam/water feed stream entered from inlet 17 is mixed with air/O₂ supply from inlet 15 as it enters the air preheat coil 59 and exits at outlet 38 of air tube 7 where it combines with fuel/air/steam/water inlets. The air tube 7 is located inside the layer of insulation 33. The combined feed streams flow through the two or three stage static mixer 8 to the top diffuser zone 5 and then flow through the velocity distributor 6. The catalyst 9 comprising a dehydrogenation portion, an oxidation portion, and a hydrodesulfurization portion occupies the space from the bottom of the velocity distributor 6 all the way to the perforated plate 39 at the bottom of the AHR. The top of the dome 41 is welded to the fuel inlet tube 18 and the dome bottom is welded to the inner surface 40 of cylinder 31.

The oxygen-to-fuel molar ratio and steam/water flow rates are adjusted such that the heat generated from the oxidation reactions is used to steam reform the remaining carbonaceous fuels and to account for preheat and any heat losses. AHR is further insulated by a layer of insulation 33 such as zircar® outside the vessel 31 to achieve a near adiabatic operation.

The well mixed feed mixture from the bottom of the velocity distributor 6 is then brought into contact with catalyst 9 resulting in formation of hydrogen rich gas (reformate gas) containing largely H₂, CO₂, CO, H₂O vapor, and N₂ at a temperature of about 700 to 800° C. The catalyst 9 is suitable for both partial oxidation and steam reforming reactions, and also is sulfur tolerant to allow downstream sulfur removal at much lower temperature (about 250 to 400° C.), and thus increases the overall energy efficiency of the fuel processor. The catalyst 9 has also been found to be exceptionally resistant to coking.

From an engineering perspective, a structured form of the AHR catalyst 9, such as a monolith or a microchannel configuration, is preferred over a pellet form especially when the reactions are severely mass-transfer-limited. With the AHR catalyst in a structured form, it offers a number of other advantages over pellets including higher catalyst effectiveness factor, less catalyst required, higher space velocities, low pressure drop and lower catalyst bed density/weight. These catalyst characteristics are essential to maintain the dynamic performance for the fuel processor.

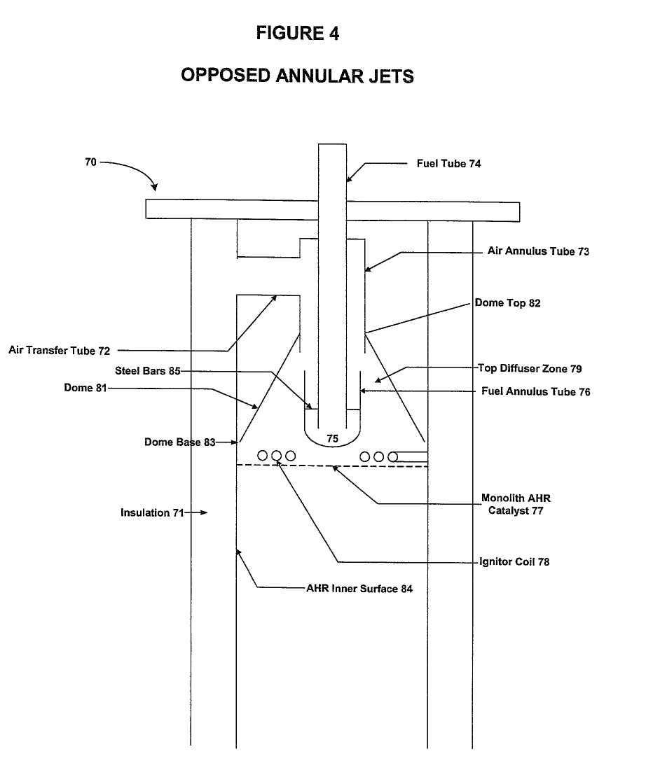

In still another embodiment of the dynamic fuel processor for converting carbonaceous fuel into hydrogen rich gases, opposed annular jets (FIG. 4) are used for mixing of the feed streams. The air/water mixture first enters through a vaporizer/preheater and then flows upward through a channel in the inner insulation 71 into the air transfer tube 72. Thus the air center tube 7 in FIG. 2 is no longer needed. The mixture then reverse direction and flows downward through the air annulus tube 73 into the top diffuser zone 79 under the dome 81. The dome top 82 is welded to the air annulus tube 73. There is a small clearance between the dome base 83 and the AHR inner surface 84, thus the dome is free to move up and down to compensate thermal expansion and contraction. The fuel annulus tube 76 is welded to the fuel tube 74 by four 90 degree apart steel bars 85. The fuel/water/steam mixture enters through the fuel tube 74 and turns back at the fuel tube outlet 75 where it flows through the fuel annulus tube 76 and mixes with the downcoming preheated air/steam mixture. The well mixed fuel/air/steam mixture from the top diffuser zone 79 is then brought into contact with micro channel monolith catalyst 77 for converting the mixture into hydrogen rich gases.

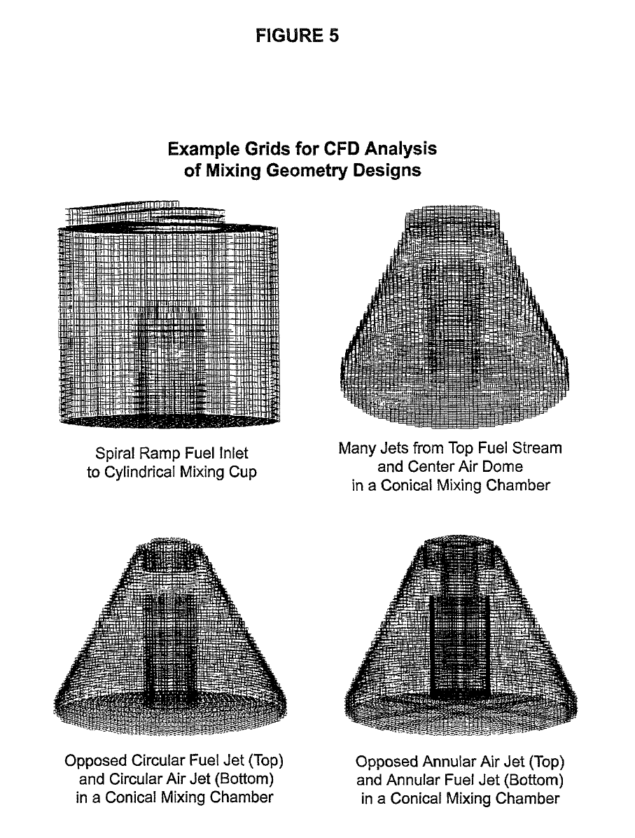

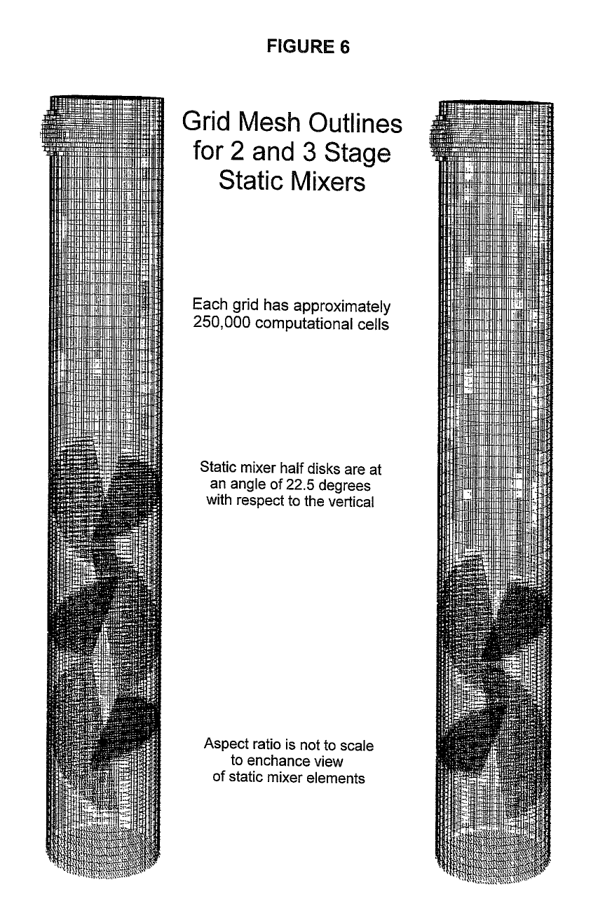

Computational fluid dynamics (CFD) was used as a design tool to optimize engineering designs for the fuel and air stream mixing and inlet geometry for the two streams to achieve good mixing before contacting the catalyst (FIGS. 2, 3 and 4). Coupled reacting flow CFD analysis showed that AHR performance is very sensitive to mixing of reactants before contacting the catalyst. Therefore extensive CFD studies were done to identify the best methods for mixing of reactants. Table 1 (pages 18-19) shows primary examples of mixing geometries analyzed with CFD. FIG. 5 shows example wire mesh views of computational grids used for CFD analysis of mixing chamber designs. FIG. 6 shows example wire mesh views of computational grids used for CFD analysis of static mixers. Table 2 (pages 19-20) lists the primary cases of CFD mixing studies.

CFD optimized mixing for AHR application consists of a multi-stage static mixer 8, FIG. 3, where the number of stages (2 to 4) is chosen to provide optimum mixing over the operating range. The height of the air tube outlet 38 above the static mixer 8 is adjusted to provide the required length for the static mixer stages. The cone shaped dome 41 of the diffuser zone 5 is not of sufficient height to yield a uniform velocity distribution into the monolith catalyst, and therefore a layer of low density foam (velocity distributor 6) is interposed above the catalyst to even out the velocity profile.

The mixing zone must be as short as possible to minimize heat losses from the reactant feed streams and so that nearly all of the heat release from the partial oxidization occurs within or just before the mixture comes into contact with the catalyst. Macroscopic mixing rates become nearly negligible once the flow enters a packed catalyst bed of pellets and are zero when the flow enters a monolith catalyst of microchannel configuration. Thorough mixing of the fuel and air streams is critical to the performance of the catalytic autothermal hydrodesulfurization reforming process. Poor mixing results in an uneven distribution of reactants (and large variation of the local oxygen-to-fuel molar ratio, χₚ) over a cross section in the catalyst normal to the flow direction. In regions of the catalyst bed where χₚ>χ (χ is the well mixed oxygen-to-fuel molar ratio), much of the carbonaceous fuel is oxidized creating a hot spot with insufficient carbonaceous fuel present for the optimum steam reforming reactions. In regions of the catalyst where χₚ<χ, too little heat is released from the oxidation reactions to provide enough energy for the endothermic steam reforming reactions, which also leads to off optimum performance. Thus, near optimum performance for the designed operating conditions requires that the flow in the mixing zone yields χₚ≈χ over the plane where the flow first contacts the catalyst.

The mixing zone geometries used in CFD analysis and mixing design are shown in Table 1 (pages 18-19). CFD analysis, interactively employed with knowledge of mixing flow field structures revealed in the analysis led to the improved mixing designs. The deviation from the mean, σ_{Φ}, of the fuel air mass equivalence ratio, Φ, for carbonaceous fuel oxidation in air was used as a quantitative measure of mixing:

$${σ}_{Φ} = {[ \frac{1}{A} {\int }_{A}^{} {( Φ - \overline{Φ} )}^{2} ⅆ A ]}^{1 / 2}$$

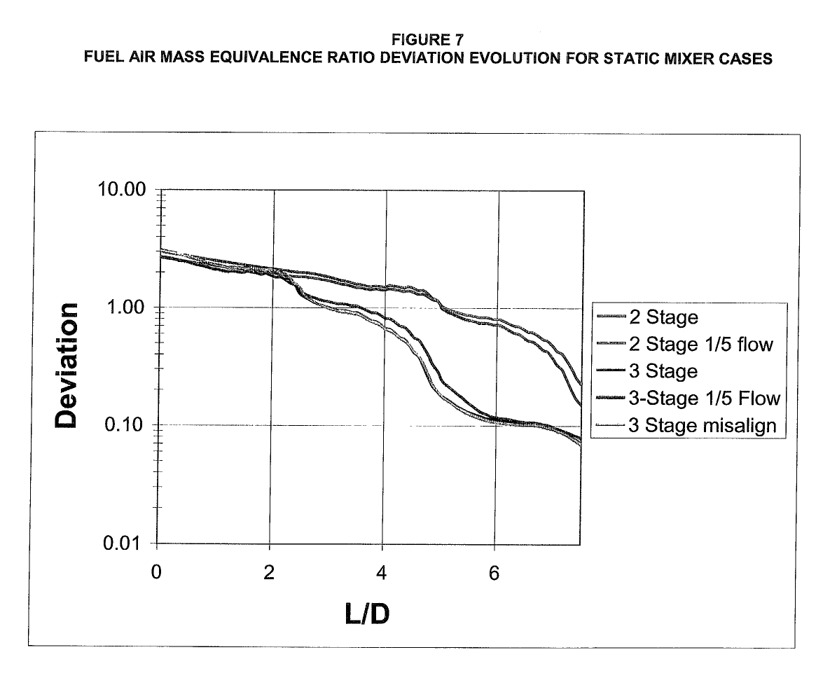

The deviation, σ_{Φ}, is computed over a cross section area, A, that is normal to the primary flow direction. This fuel air mass equivalence ratio, Φ, is related to the oxygen to fuel molar ratio, χ, through molecular weights and stoichiometric coefficients of the balanced oxidation reaction of carbonaceous fuel in air. The mass ratio is convenient to use in CFD analysis because the governing equations that are solved include chemical species transport partial differential equations in a form expressing the conservation of mass. Good mixing is quantitatively indicated by small values of the deviation of either ratio from the mean. Turndown computations were done for the best mixing designs with the mass flow rates of both the fuel and air streams reduced by a factor of five. The extent of mixing decreased only slightly in these cases, which enables the fuel processor to maintain desirable performance characteristics such as fast response to load change capabilities (FIG. 7).

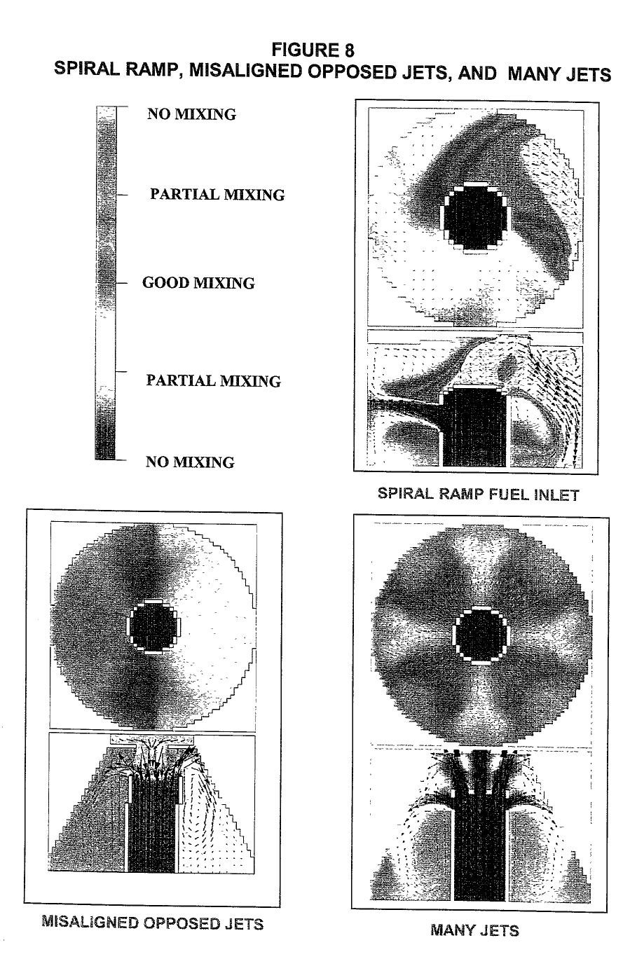

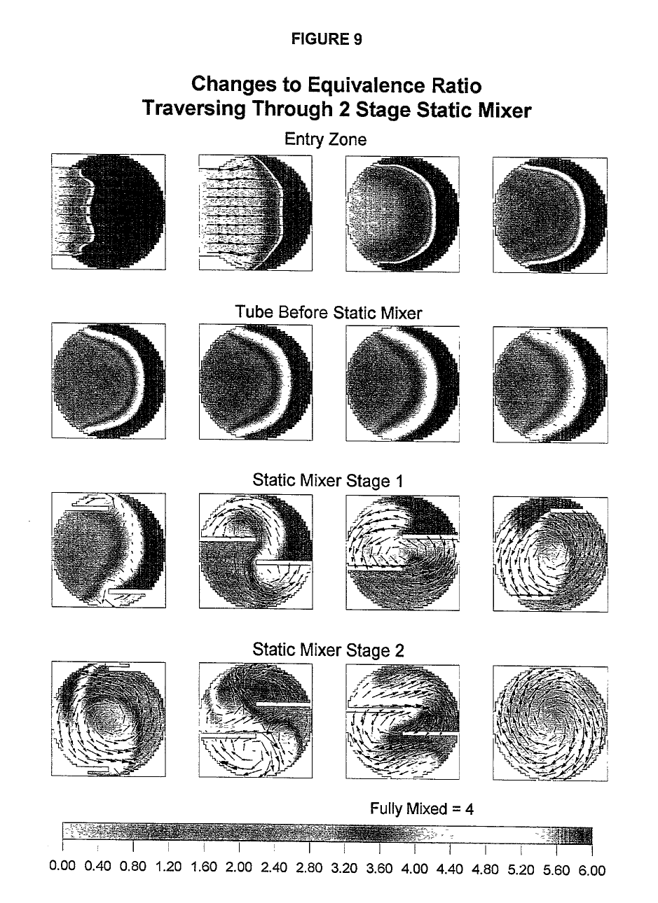

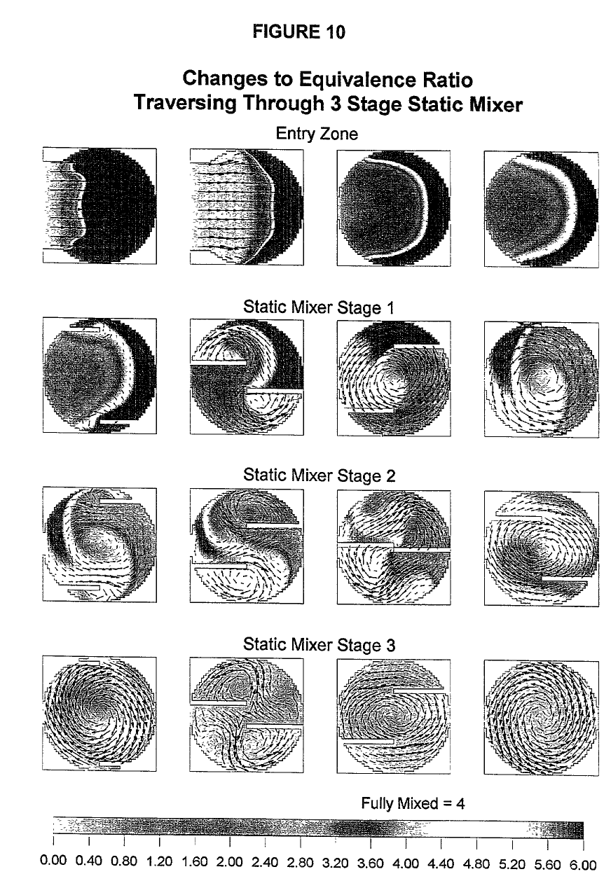

The color spectrum plots in FIGS. 8, 9 and 10 indicate the distribution of mass concentration of both the fuel and air streams in terms of fuel air mass ratio or its inverse. In FIG. 8, gray regions are all fuel/steam; red regions are all air/steam. In FIGS. 9 and 10, the color spectrum is reversed (red indicates all fuel/steam and gray indicates all air/steam). In both cases, intermediate colors indicate partially to fully mixed conditions, with a uniform green indicating complete mixing. Computational results for the spiral ramp fuel inlet design are shown in the upper right of FIG. 8. The circular slice just above the catalyst shows that fuel and air streams are not well mixed. The vertical slice with velocity vectors shows that even though the spiral ramp fuel inlet creates swirl at the top of the mixing cup, much of the fuel stream flows preferentially to the side of the cup that is normal to the fuel ramp inlet opening. The case with many small jets (FIG. 8), including a large number of vertical fuel jets and 8 orthogonal and 9 vertical air jets, shows much better mixing. However, the small orthogonal air jets are turned down by the primary flow and do not completely mix by the time they reach the catalyst bed. In the case of perfectly aligned single opposed circular fuel and air jets with the air tube extending to within ¼ inch of the fuel inlet jet, mixing is nearly complete when the flow contacts the catalyst bed. The mechanical design of this configuration could not ensure opposed jet alignment, and results of CFD analysis of mixing for the design of FIG. 2 are shown to be inadequate for a misalignment of 1/24 inch in FIG. 8. Mixing for opposed annular jets is also shown to be reasonably good, but probably requiring additional refinement for AHR application. Mixing flow field results for 2 and 3 stage static mixers are shown in FIGS. 9 and 10 respectively. The alternating direction turbulent vortex mixing for these mixers appears to be excellent. An example of evolution of the equivalence ratio deviation, σ_{Φ}, as the reactant streams pass through 2 and 3 stage mixers is shown in FIG. 7 for cases with full reactant flow rate, a turndown to ⅕ of maximum flow rate, and a hypothetical static mixer with elements axially misaligned by 1/20 inch during manufacture (Table 2, pages 20-21). These results show that mixing performance for static mixers is relatively insensitive to misalignment and that mixing will remain adequate for the design turndown ratio of 5.

The reactant mixing method of this invention includes both the use of an inline static mixer and the sizing of the tube containing the mixer to maintain a turbulent flow regime in the static mixer tube throughout the range of mass flow rates covering the AHR design operation limits. A near minimum theoretical mixing length is achieved when the Taylor macro scale of turbulent vorticies is of the order of the equipment scale. This mixing length is relatively independent of Reynolds number once the Reynolds number is high enough to achieve a turbulent flow. Therefore, minimum pressure drop through the static mixer is achieved by sizing the tube with the mixer so that the diameter will yield a near minimum Reynolds number for turbulent flow at the minimum design flow rate.

Table 2 (pages 20-21) summarizes the case characteristics of CFD mixing studies for this invention. A summary of primary mixing results for different mixing methods and designs is given quantitatively in Table 3 (pages 22-23). These results, in terms of the equivalence ratio deviation, σ_{Φ}, at the end of the static mixer or the mixing chamber show that a static mixer designed as defined above provides the best reactant mixing for AHR application.

[image]

[image]

TABLE 2
PRIMARY CASES OF PARAMETRIC MIXING STUDY

| | Fuel/Steam | Air Inlet | Mixing Zone | |
|---|---|---|---|---|
| Case | Inlet Geometry | Geometry | Geometry | Mixing Method |
| 300-301 - ⅛″-¼″ | ⅛″-¼″ spiral | 5 × ¼″ OD | 1″ - OD | Orthogonal air jets |
| high spiral ramp | ramp at top | holes 5/16″ | cylinder, 1″ high | with |
| fuel jet inlet | center of | above bed | | some swirl in fuel jet |
| | cylinder | | | |
| 400-404 - Many | Disk with holes | ⅛″ from top | 2″ base cone, | Many jets, ˜½ |
| jets, ⅛″-¼″ Air | in inlet tube/404 | ˜17 holes to | 1″ high | opposed |
| Dome Gap | open | give 90 fps | | |
| 405-408 - Opposed | ˜90 fps center jet | ˜90 fps jet in top | 2″ base cone, | Opposed Circular |
| Jets ⅛″-½″ Air | via plate in tube | of air dome | 1″ high | Jets |
| Dome Gap** | | | | |
| 420-425 - Opposed | ˜18 fps center jet | ˜18 fps jet in top | 2″ base cone, | Opposed Circular |
| Jets ⅛″-½″ Air | via plate in tube | of air dome | 1″ high | Jets |
| Dome Gap** | | | | |
| 430-435 - Opposed | ˜90 fps center jet | ˜90 fps jet in top | 2″ base cone, | Opposed Circular |
| Jets ¼″-1″ Air | via plate in tube | of air dome | 1″ high | Jets |
| Dome Gap | | | | |
| Jets Misaligned by | | | | |
| 1/24″ | | | | |
| 502-503 - Opposed | ˜90 fps center jet | ˜90 fps jet in top | 2.563″ base cone | Opposed Circular |
| Jets ¼″-⅜′ Air | via plate in tube | of air dome | 1.5″ high | Jets |
| Dome Gap** | | | | |
| 600 - Opposed Jets | ˜80 fps center jet | ˜120 fps jet in | 2.563″ base cone, | Opposed Annular |
| ¼″ Annulus Tube | via plate in tube | top of air dome | 1.5″ high | Jets |
| Gap** | | | | |
| 602 - Opposed Jets | ˜80 fps centerjet | ˜120 fps jet in | 2.563″ base cone, | Opposed Annular |
| ¼″ Annulus Tube | via plate in tube | top of air dome | | Jets |
| Gap, | via plate in tube | top of air dome | 1.5″ high Jets | |
| Steam in Air | | | | |
| Stream** | | | | |
| 624-625 - Static | ˜14 fps in feed | ˜40 fps side | 3 Stage static | Cutting & stretching |
| mixer 3-Stage, air | tube; | inlet air tube | mixer with flat | of fluid streams with |
| inlet just above | (Reynolds | | elements crossed | axial alternating |
| mixer; steam in air | number with air | | at 45 deg. to the | direction large |
| stream* | into mixer | | vertical in 1″ | turbulent vortex |
| | ˜4000) | | tube | |
| 628 - Static mixer | ˜18 fps in feed | ˜62 fps side | 2 Stage static | Cutting & stretching |
| 2-Stage, air inlet | tube; | inlet air tube | mixer with flat | of fluid streams with |
| ˜5″ above mixer; | (Reynolds | | elements crossed | axial alternating |
| steam in air stream* | number with air | | at 22.5 deg. to | direction large |
| | into mixer | | the vertical in | turbulent vortex |
| | ˜6000) | | 0.65″ I.D. tube | |
| 629 - Static mixer | ˜3.6 fps in feed | ˜12.4 fps side | 3 Stage static | Cutting & stretching |
| 2-Stage, air inlet | tube; (Reynolds | inlet air tube | mixer with flat | of fluid streams with |
| ˜5″ above mixer; | number with air | (⅕ turndown of | elements crossed | axial alternating |
| steam in air stream* | into mixer | case 628 flow | at 22.5 deg. to | direction large |
| (632: 3 stage*) | ˜1200) | rate) | the vertical in | turbulent vortex |
| | | | 0.65″ tube | |
| 630-631 - Static | ˜18 fps in feed | ˜62 fps side | 3 Stage static | Cutting & stretching |
| mixer 2-Stage, air | tube; | inlet air tube | mixer with flat | of fluid streams with |
| inlet ˜5″ above | (Reynolds | | elements crossed | axial alternating |
| mixer; steam in air | number with air | | at 22.5 deg. to | direction large |
| stream* (631: | into mixer | | the vertical in | turbulent vortex |
| misaligned | ˜6000) | | 0.65″ tube | |
| elements) | | | (misaligned by | |
| | | | 1/20″) | |

*Good mixing
**Good mixing but highly sensitive to alignment

TABLE 3
SUMMARY OF FUEL-AIR MASS EQUIVALENCE RATIO
DEVIATION OVER ENTRY TO CATALYST BED OR END OF
STATIC MIXER FOR ALTERNATIVE DESIGNS

| Category | Case | Case No. | Eq. R. Dev.* |
|---|---|---|---|
| Spiral ramp | 5 orthogonal jets 5/16″ | 301 | 2.44 |
| Fuel inlet | above catalyst bed | | |
| Opposed Jets | ¼″ gap, 1″ cone | 406 | 0.10 |
| Opposed Jets | ¼″ gap, 1″ cone | 420 | 0.12 |
| | Flow rate ⅕ that | | |
| | of case 406 | | |
| Opposed Jets | ¼″ gap, 1.5″ cone | 502 | 0.12 |
| Misaligned | ¼″ gap, 1.5″ cone | 507 | 1.60 |
| Opposed Jets | | | |
| Annular Jets | ¼″ gap, 1.5″ cone | 600 | 0.51 |
| | no steam in air stream | | |
| Annular Jets | ¼″ gap, 1.5″ cone | 602 | 0.46 |
| | 20 cc/min steam in fuel | | |
| | 15 cc/min steam in air | | |
| Static Mixer | ¼″ gap, 1.5″ cone | 628 | 0.15 |
| 2-Stage | 20 cc/min steam in fuel | | |
| | 15 cc/min steam in air | | |
| Static Mixer | ¼″ gap, 1.5″ cone | 629 | 0.23 |
| 2-Stage | ⅕ flow rate turndown | | |
| Static Mixer | ¼″ gap, 1.5″ cone | 630 | 0.07 |
| 3-Stage | | | |
| Misaligned | ¼″ gap, 1.5″ cone | 631 | 0.07 |
| Static Mixer | Mixer | | |
| 3-Stage | | | |
| Static Mixer | ¼″ gap, 1.5″ cone | 632 | 0.08 |
| 3-Stage | ⅕ flow rate turndown | | |

*The equivalence ratio deviations in Table 3 are over the cross section directly above the catalyst bed when the mixing is designed to occur in a mixing chamber and are at the end of the last stage of a static mixer for the static mixer cases.

The hot AHR reformate gas exits at the bottom of AHR and turns upward to flow through the annulus 50 (FIGS. 2 and 3) between the cylinders 21 and 31 defined as the vaporizer/preheater where the hot reformate gas is cooled by transferring its sensible heat to preheat as well as generating super-heated steam in finned/bellowed helical tube 59.

The reformate gas then flows downward into the annulus between the cylinders 11 and 21, where a ZnO catalyst 19 in sulfur removal reaction zone 22 and a WGS catalyst 29 in the WGS reaction zone 25 are housed. The entire length of WGS reaction zone is embedded with a heat-transfer finned/bellowed helical boiler coil 60 in which the water fed to the WGS reactor is vaporized and superheated. This super-heated steam is mixed with fuel, air and water, and the mixture is then combined with the preheated air/steam before supplying to AHR.

Liquid water (referred to as water) can be injected directly to the top of the zinc oxide bed 22 to help cool the reformate gas to about 350 to 400° C. This additional water also promotes the WGS reaction in the WGS reactor 25 that follows. The WGS boiler coil 60 can cool the reformate gas to about 200 to 250° C. The cylinder 11 can be water jacketed with inner vertical fins to allow additional control of the reformate gas temperature. The reformate gas exits at the bottom of the fuel processor vessel 26.

The fuel/water/steam/oxidant mixture can be ignited with an electric igniter 35 that is used only for start-up, i.e., after start-up, the igniter 35 is turned off and the fuel processor is self-sustained. The igniter 35 is an ⅛″ OD electric resistance heating coil located underneath the dome 41.

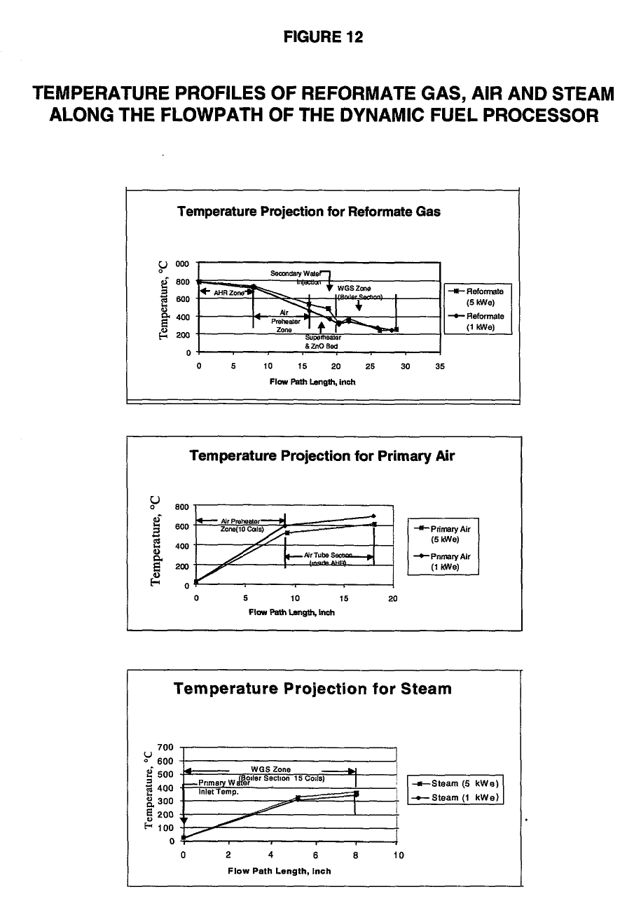

The temperatures of the AHR catalyst bed 32 are measured radially and longitudinally by a series of thermocouple wells inserted into the catalyst bed 32 from the top of the fuel processor 10. The temperatures of the zinc oxide and the WGS beds in the outer annular zones 22 and 25 are monitored radially and longitudinally by thermocouples inserted through the vessel wall 11. For commercial applications, only those temperatures required to regulate the feed flow rate settings are measured. FIG. 12 shows the projected temperature ranges calculated from modeling of the fuel processor for the reformate gas, air, and steam along their respective flow paths through the fuel processor operating at 1 and 5 kWe energy outputs, respectively. The temperatures at the air tube (or air center tube) outlet and WGS boiler coil outlet were projected to be in the ranges of 600 to 700° and 330 to 370° C., respectively. The reformate gas was projected to reach about 700 to 800° C. at the top of AHR and would be gradually cooled down to about 200 to 250° C. by transferring its sensible heat to air and steam/water along the flow path in the annulus 50, 22, and 25.

The reformate gas exits the fuel processor 10 at about 200 to 250° C. containing 44 to 50 mol % H₂, 10 to 16 mol % CO₂, 0.8 to 2 mol % CO, and the balance for N₂ and unconverted fuel on a dry basis fuel. Air can be injected into the WGS reactor 25 such that the PROX reaction is occurring in the WGS reactor 25 to further reduce the CO concentration to less than about 0.5 mol % (dry basis). The final CO contaminant reduction of the reformate gas to less than 10 ppm levels required by the PEM fuel cell stacks is optimally approached using a catalytical multistage PROX reactor. The flanged-stage PROX reactor design allow for rapid assembly and disassembly and reconfiguration of the internal reactor including changing of the catalysts. The actual number of stages required depends on the inlet reformate gas composition and the final CO contaminant reduction needed for the fuel cell stacks.

The following examples illustrate some of the dynamic fuel processors of the invention. These examples shall not be regarded as restricting the scope of the invention, as they are only examples of employing the apparatus and method of the dynamic fuel processors according to the invention.

### EXAMPLE 1

A dynamic fuel processor having 9″ diameter and 16″ long (PROX reactor is not included in the dimensions) was loaded with approximate 0.5 kg of autothermal hydrodesulfuring reforming catalyst (FIG. 3). The temperature in the catalyst bed was kept at about 700 to 750° C., and the pressure was kept at about 2 psig. The flow rates for the feeds were: 1.3870 gmol per minute natural gas, 3.8308 gmol per minute air, and 1.9418 gmol per minute water. Table 4 presents the AHR products, which were cooled before they were directed to the zinc oxide bed where the sulfur impurities were removed. The zinc oxide bed outlet temperature was kept at about 350° C.

The sulfur free reformate gas then entered the single stage WGS reactor packed with our improved WGS catalysts. The gas temperature was further declined to about 250° C. across the WGS reactor. Table 5 presents the WGS products where CO was reduced to about 0.8 mol % (dry):

The final CO contaminant reduction reaction to less than 10 ppm is optimally approached using a catalytic PROX step. Table 6 presents the PROX products which were then fed to the PEM fuel cell stacks for generating about 6 kWe power.

TABLE 4
AHR PRODUCTS

| ATR | | Vol %, | Vol %, | LHV | | |
|---|---|---|---|---|---|---|
| Products | gmol/min | wet | dry | Btu/hr | kWt | kWe* |
| H₂ | 3.1146 | 34.22 | 41.37 | 42,809.70 | 12.5379 | 5.0152 |
| CO | 0.7703 | 8.46 | 10.23 | | | |
| CO₂ | 0.6038 | 6.63 | 8.02 | | | |
| N₂ | 3.0263 | 33.25 | 40.20 | | | |
| CH₄ | 0.0137 | 0.15 | 0.18 | | | |
| H₂O | 1.5737 | 17.29 | — | | | |
| TOTAL | 9.1024 | 100.00 | 100.00 | | | |

Efficiency**_{ATR} = 67.84%

TABLE 5
WGS PRODUCTS

| WGS | | Vol %, | Vol %, | LHV | | |
|---|---|---|---|---|---|---|
| Products | gmol/min | wet | dry | Btu/hr | kWt | kWe* |
| H₂ | 3.8199 | 41.96 | 46.39 | 52,503.93 | 15.3771 | 6.1508 |
| CO | 0.0651 | 0.72 | 0.79 | | | |
| CO₂ | 1.3090 | 14.38 | 15.90 | | | |
| N₂ | 3.0263 | 33.25 | 36.75 | | | |
| CH₄ | 0.0137 | 0.15 | 0.17 | | | |
| H₂O | 0.8684 | 9.54 | — | | | |
| TOTAL | 9.1024 | 100.00 | 100.00 | | | |

Efficiency**_{WGS} = 83.21%

TABLE 6
PROX PRODUCTS

| PROX | | Vol %, | Vol %, | LHV | | |
|---|---|---|---|---|---|---|
| Products | gmol/min | wet | dry | Btu/hr | kWt | kWe* |
| H₂ | 3.7548 | 40.16 | 44.63 | 51,609.15 | 15.1150 | 6.0460 |
| CO | 0.0000 | 0.00 | 0.00 | | | |
| CO₂ | 1.3741 | 14.70 | 16.33 | | | |
| N₂ | 3.2712 | 35.00 | 38.88 | | | |
| CH₄ | 0.0137 | 0.15 | 0.16 | | | |
| H₂O | 0.9335 | 9.99 | — | | | |
| TOTAL | 9.3473 | 100.00 | 100.00 | | | |

Efficiency**_{PROX} = 81.79%
*80% fuel utilization plus 50% fuel cell stack efficiency are used in the calculations for fuel cell electric power generation
**The energy efficiency (%) is defined as LHV of H₂ produced/LHV of fuel input × 100

### EXAMPLE 2

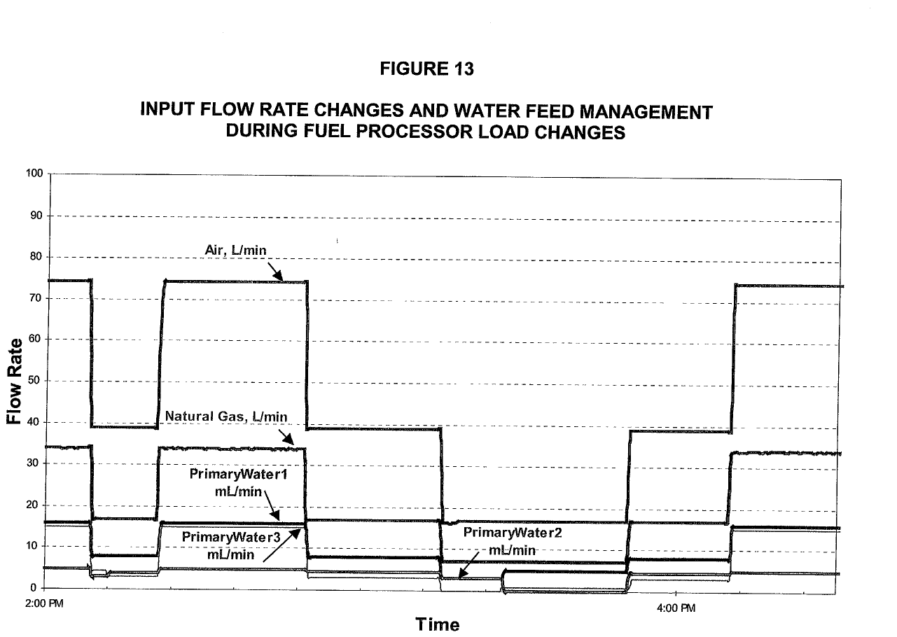

At time, PM, 2:00, the dynamic fuel processor of Example 1 was fed: 1.387 gmol/min (33.93 L/min) natural gas, 3.040 gmol/min. (74.33 L/min) air, and 1.990 gmol/min (36.00 mL/min) water. The temperature in the AHR catalyst bed was kept at about 650 to 700° C., and the pressure was kept at about 2 psig. After 9 minutes, the feed rates were cut in half for 12 minutes, then the feed rates were resumed for 29 minutes before they were cut in half again for 26 minutes. The feed rates were further cut to one fifth for 35 minutes before they were resumed in two steps to their original values (FIG. 13).

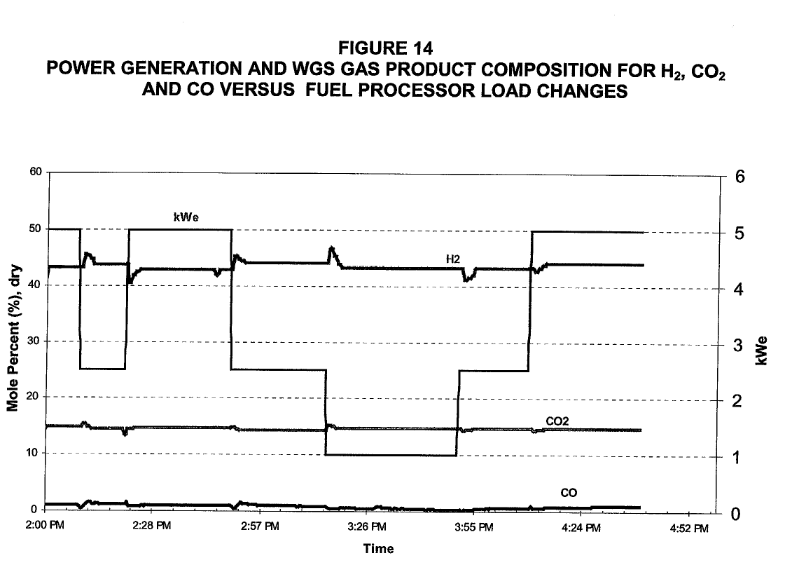

The water flow rates to the air preheat coil, to the top of AHR, and to the WGS boiler tube were adjusted automatically to maintain the original temperature profiles in the AHR, the WGS reactor and the original zinc oxide bed outlet temperature during load changes (FIG. 13). The temperature profiles, the zinc oxide bed outlet temperature, product gas compositions and power generation, kWe, are quite stable after these sharp feed rate changes (FIG. 14, Table 7), which means that the fuel processor of this invention is dynamic and capable of fast response to load changes.

TABLE 7
FAST RESPONSE OF THE FUEL PROCESSOR
TO LOAD CHANGES

| | Flow Rates | | | WGS Products | | | | |
|---|---|---|---|---|---|---|---|---|
| | Nat. | | | | | | | |
| Time, | Gas | Air | Water | mol %, dry | | | | |
| PM | L/min | L/min | mL/min | H2 | CO | CO2 | N2 | kWe |
| 2:00 | 33.93 | 74.33 | 36.00 | 43.24 | 1.19 | 14.81 | —* | 5.0 |
| 2:09 | 16:92 | 38.89 | 15.50 | | | | | |
| 2:10 | 16.92 | 38.88 | 15.50 | 45.61 | 1.10 | 14.95 | — | 2.5 |
| 2:11 | 16.91 | 38.87 | 15.50 | 45.28 | 1.65 | 14.56 | — | 2.5 |
| 2:12 | 16.94 | 38.87 | 15.50 | 44.71 | 1.59 | 14.53 | — | 2.5 |
| 2:13 | 16.91 | 38.88 | 15.50 | 43.81 | 1.47 | 14.54 | — | 2.5 |
| 2:21 | 33.94 | 74.33 | 36.00 | | | | | |
| 2:22 | 33.92 | 74.32 | 36.00 | 40.52 | 0.93 | 14.53 | — | 5.0 |
| 2:23 | 33.91 | 74.34 | 36.00 | 41.78 | 0.98 | 14.67 | — | 5.0 |
| 2:24 | 33.92 | 74.32 | 36.00 | 42.46 | 1.04 | 14.73 | — | 5.0 |
| 2:25 | 33.92 | 74.32 | 36.00 | 42.88 | 1.03 | 14.77 | — | 5.0 |
| 2:45 | 33.92 | 74.32 | 36.00 | 42.07 | 1.22 | 14.61 | 38.59 | 5.0 |
| 2:50 | 16.93 | 38.88 | 15.50 | | | | | |
| 2:51 | 16.94 | 38.87 | 15.50 | 45.26 | 0.88 | 14.94 | — | 2.5 |
| 2:52 | 16.92 | 38.88 | 15.50 | 44.80 | 1.63 | 14.46 | — | 2.5 |
| 2:53 | 16.93 | 38.89 | 15.50 | 44.36 | 1.62 | 14.39 | — | 2.5 |
| 2:54 | 16.92 | 38.88 | 15.50 | 44.04 | 1.51 | 14.43 | — | 2.5 |
| 3:02 | 16.92 | 38.87 | 1.550 | 44.37 | 1.25 | 15.53 | 37.30 | 2.5 |
| 3:16 | 6.95 | 16.32 | 6.00 | | | | | |
| 3:17 | 6.94 | 16.33 | 6.00 | 44.67 | 0.62 | 15.16 | — | 1.0 |
| 3:18 | 6.95 | 16.88 | 6.00 | 45.29 | 0.61 | 14.97 | — | 1.0 |
| 3:19 | 6.95 | 16.91 | 6.00 | 43.99 | 0.67 | 14.77 | — | 1.0 |
| 3:20 | 6.94 | 16.90 | 6.00 | 43.15 | 0.82 | 14.70 | — | 1.0 |
| 4:05 | 16.92 | 38.87 | 15.50 | 44.17 | 0.99 | 14.71 | 35.54 | 2.5 |
| 4:21 | 33.93 | 74.32 | 36.00 | 44.33 | 1.16 | 14.80 | 35.35 | 5.0 |

While the invention has been described with reference to one or more preferred embodiments, it will be understood by those skilled in the art that various changes can be made and equivalents can be substituted for parts, elements, components and process steps thereof without departing from the scope of the invention. In addition, many modifications can be made to adapt a particular situation or material to the teachings of the invention without departing from the essential scope thereof. Therefore, it is intended that the invention not be limited to the particular embodiments disclosed as the best modes contemplated for carrying out this invention, but that the invention includes all embodiments and equivalents falling within the scope of the appended claims.

What is claimed is:

1. A dynamic fuel processor for converting carbonaceous fuels into hydrogen rich gases for fueling fuel cells or chemical processing applications, comprising:
vaporizer and preheater for vaporizing liquid fuels and water and for preheating feeds by transferring sensible heat from reformate gas;
a feed mixer for providing reactant mixing, said feed mixer comprising a static mixer, opposite jets or opposed annular jets;
an AHR for combining heat effects of partial oxidation, steam reforming reactions, preheat and heat losses by feeding fuel, water and an oxidant over a sulfur tolerant three part catalyst to yield a hydrogen rich reformate gas;
a zinc oxide sulfur trap for removing sulfur impurities at lower temperature ranging from 250 to 400° C.;
a WGS reactor for converting CO and water in the reformate gas to CO₂ and for producing hydrogen via a WGS reaction;
a steam generator for vaporizing and superheating water fed to a WGS boiler coil; and
a PROX (preferential oxidation) reactor portion for reducing CO levels.

2. The fuel processor of claim 1 comprising a concentric vessel design to allow simplified thermal management.

3. The fuel processor of claim 1 comprising an inner cylinder extending substantially the height of an outer cylinder and cooperative therewith to provide an AHR.

4. The fuel processor of claim 1 comprising a static mixer wherein fuel is mixed with superheated steam from a WGS boiler tube, and air and water are supplied to said AHR via a fuel inlet tube.

5. The fuel processor of claim 1 comprising a static mixer wherein oxidant air is mixed with water/steam supply before entering an air preheater coil and said AHR via a fuel inlet tube.

6. The fuel processor of claim 1 comprising a static mixer wherein the oxygen to fuel molar ratio and steam/water flow rates are adjusted such that the heat generated from the oxidation reaction is used to steam reform the remaining carbonaceous fuels and to account for preheat and any heat losses in order to achieve the maximum energy efficiency.

7. The fuel processor of claim 6 wherein the AHR is further insulated by a layer of insulation such as zircar outside the AHR vessel to achieve a near adiabatic operation in the AHR.

8. The fuel processor of claim 1 comprising a middle cylinder is provided with a layer of insulation such as zircar outside the vessel.

9. The fuel processor of claim 1 comprising an annulus between inner and middle cylinders embedded with helical coil for providing an evaporator/preheater.

10. The fuel processor of claim 1 comprising an annulus between outer and middle cylinders and a perforated plate for supporting a zinc oxide bed.

11. The fuel processor of claim 1 comprising an annulus between outer and middle cylinders, and within the confines of the two perforated plates is served as a WGS reactor.

12. The fuel processor of claim 11 the entire length of the WGS reactor is embedded with helical boiler coil served as a steam generator.

13. The fuel processor of claim 1 comprising an air preheater coil and WGS boiler coil with compact finned/bellowed helical coils for temperature control.

14. The fuel processor of claim 1 comprising three part sulfur tolerant AHR catalysts to allow low temperature operations in said AHR at about 600 to 800° C. for higher energy efficiency.

15. The fuel processor of claim 11 wherein the AHR catalysts are suitable for both partial oxidation and steam reforming reactions.

16. The fuel processor of claim 14 wherein the use of sulfur tolerant AHR catalysts further allows downstream sulfur removal at lower temperatures at about 250 to 400° C. for higher energy efficiency.

17. The fuel processor of claim 14 comprising higher activity and structured form of a monolith AHR catalysts allows a smaller fuel processor and less thermal mass to build a faster response to load changes, higher energy efficiency and lower cost fuel processor.

18. The fuel processor of claim 1 comprising a static mixer wherein the feed of water/steam to AHR reduces the tendency to form coke and produces less CO.

19. The fuel processor of claim 1 comprising a PROX reactor portion with a section for higher CO input and controlled CO output.

20. The fuel processor of claim 1 comprising a static mixer wherein water flow rates to the air preheat coil, to the top of the AHR, and to the WGS boiler coil are adjusted automatically to maintain the original temperature profiles in the AHR, WGS reactor, and the zinc oxide bed outlet temperature during load changes in order to maintain desirable performance characteristics including rapid start-stop and fast response to load changes.

21. The fuel processor of claim 1 comprising a WGS catalyst working at low to medium temperatures to eliminate the need for one additional WGS reactor and an interstage heat exchanger.

22. The fuel processor of claim 1 comprising a precious metal, non-pyrophoric WGS catalyst for reducing WGS catalyst volume to 68% of that of the commercial Fe/Cr—Cu/ZnO combination.

23. The fuel processor of claim 22 wherein said WGS catalyst are precious metal, non-pyrophoric catalyst.

24. The fuel processor of claim 1 comprising a single stage WGS reactor with smaller size, volume and weight.

25. The fuel processor of claim 1 with opposite jets wherein the fuel is mixed with superheated steam from a WGS boiler tube, air and water before it is supplied to said AHR via a fuel inlet tube.

26. The fuel processor of claim 1 with opposite jets wherein oxidant air is mixed with water/steam supply before entering an air preheater coil and supplying to AHR via a air center tube.

27. The fuel processor of claim 1 comprising opposed annular jets for mixing of the feed streams.

28. The fuel processor of claim 1 comprising a fuel inlet tube and an air center tube connected via a dome and four steel bars as one union freely move vertically up and down to compensate for thermal expansion and contraction.

29. The fuel processor of claim 1 comprising a fuel inlet tube and an air tube outlet connected upstream of a static mixer.

30. The fuel processor of claim 1 comprising a static mixer with a minimum number of stages to provide a reactant mixing at the scale of monolith catalyst channel hydraulic diameter.

31. The fuel processor of claim 1 comprising a tube containing the static mixer having a diameter that yields a near minimum Reynolds number for turbulent flow at the minimum design flow rate to achieve good mixing between fuel and air streams with minimum pressure drop before entering the top of the AHR.

32. The fuel processor of claim 1 comprising a static mixer configuration for mixing of feeds superior to many jets, opposed jets, spiral ramp fuel stream inlet or opposed annular jets in mixing chamber configurations.

33. The fuel processor of claim 1 comprising a static mixer wherein computational fluid dynamics is used as a design tool to optimize engineering mixing designs for the dynamic fuel processor.

34. The fuel processor of claim 1 comprising a static mixer wherein air and/or water are fed to the top of said AHR in order to control AHR temperature.

35. The fuel processor of claim 1 comprising a static mixer wherein liquid water can be injected directly to a zinc oxide bed to help cool reformate gas to about 350 to 400° C.

36. The fuel processor of claim 35 wherein the water can be injected in the form of steam.

37. The fuel processor of claim 35 wherein the water can be added in atomized form via an atomizer to enhance the heat transfer by absorbing heat through a phase change and resulting in a compact cooling zone.

38. The fuel processor of claim 35 wherein additional water is injected to a zinc oxide bed for promoting water-gas shift reaction in the WGS reactor.

39. The fuel processor of claim 1 comprising a helical cooling water coil across the WGS reactor to vaporize and superheat water which is then mixed with fuel.

40. The fuel processor of claim 1 comprising an outer concentric cylinder with a water jacket to allow additional control of the reformate gas temperature.

41. The fuel processor of claim 40 wherein an inside said water jacket comprises fins for higher heat transfer rates.

42. The fuel processor of claim 1 comprising a heating coil installed underneath a dome to ignite the fuel/steam/oxidant mixture for start-up.

43. The fuel processor of claim 1 wherein a velocity distributor is installed at the outlet of a top diffuser zone to further ensure good mixing of the feeds.

44. The fuel processor of claim 1 comprising a static mixer wherein the temperatures are controlled to decline from the top of said AHR to the exit of a PROX unit.

45. The fuel processor of claim 1 wherein the temperature is controlled to decline across a WGS reactor, from about 350° C. to about 220° C.

46. The fuel processor of claim 1 comprising a WGS reactor containing a low temperature shift reaction catalyst suitable for operating at a temperature between 100 and 220° C. before a PROX unit to further reduce the CO concentration.

47. The fuel processor of claim 1 wherein means to supply fuel, oxidant, water/steam and superheated steam share a common tube.

48. The fuel processor of claim 1 wherein means to supply oxidant air and water/steam share a common tube.

49. The fuel processor of claim 1 comprising a replaceable catalyst cartridge that can accommodate catalysts in the forms of monoliths, pellets, foams, and screens is used in a zinc oxide bed.

50. The fuel processor of claim 49 wherein the catalyst cartridge comprises a catalyst cartridge for removing sulfur contains zinc.

51. The fuel processor of claim 1 wherein oxidant/water mixture is preheated in an air preheater coil by AHR product gases before it is mixed with the other feed stream.

52. The fuel processor of claim 51 wherein the flow of the vaporizer/preheater is countercurrent to the flow of reformate gas through the vaporizer/preheater.

53. The fuel processor of claim 1 wherein water is preheated to superheated steam in a WGS boiler coil by the desulfured reformate gas before it is mixed with the fuel feed stream.

54. The fuel processor of claim 53 wherein the flow of water/steam in a steam generator is countercurrent to the flow of reformate gas through a WGS reactor.

55. The fuel processor of claim 1 wherein heated water/steam can be generated by burning the unused hydrogen emanating from a fuel cell.

56. The fuel processor of claim 55 wherein heated water/steam can be supplied to the fuel processor.

57. The fuel processor of claim 1 wherein fuel/oxidant/water/steam feed supply regulators are controlled by an electronic device.

58. The fuel processor of claim 57 wherein the electronic device uses variable inputs to calculate the settings of the feed supply regulators.

59. The fuel processor of claim 58 wherein the variable inputs include one or more of the AHR, zinc oxide bed, WGS reactor and PROX temperatures.

60. The fuel processor of claim 59 wherein a zinc oxide bed inlet temperature is the variable input to calculate the setting of the water supply to the air preheat coil.

61. The fuel processor of claim 59 wherein a zinc oxide bed outlet temperature is the variable input to calculate the setting of the additional water supply to a zinc oxide bed.

62. The fuel processor of claim 59 wherein a WGS reactor outlet temperature is the variable input to calculate the setting of the water supply to the WGS boiler coil.

63. The fuel processor of claim 1 wherein water supply to the top of said AHR is the balance of the total water supply and the water supplied to the air preheat coil, the zinc oxide bed and the WGS boiler coil.

64. The fuel processor of claim 1 wherein an air supply to the top of said AHR provides the balance of the total air supply and the air supplied to the air preheat coil.

65. The fuel processor of claim 1 wherein AHR outlet temperature provides the variable input to calculate the setting of oxidant supply to the fuel processor.

66. The fuel processor of claim 1 wherein reformate gas flow is diverted during abnormal operation conditions until the measured CO value in the reformate gases is below a critical level.

67. The fuel processor of claim 66 wherein the critical CO level for a PEM fuel cell is 100 ppm or below.

68. The fuel processor of claim 66 where a bypass valve diverts reformate gas flow to a tailgas burner.

69. The fuel processor of claim 1 wherein the operating pressure of the fuel processor is less than or equal to 1200 psia.

70. The fuel processor of claim 1 wherein the pressure drop of the fuel processor is 5 psi or less.

71. The fuel processor of claim 1 wherein the available fuels for the fuel processor include hydrocarbons selected from the group consisting of gasoline, diesel, naphtha, natural gas, liquefied petroleum gas, and alcohols selected from the group consisting of methanol, and ethanol.

72. The fuel processor of claim 1 wherein the oxidant comprises air.

73. The fuel processor of claim 1 wherein the oxidant comprises enriched air or pure oxygen

74. The fuel processor of claim 1 comprising a multi-stage static mixer operated at various loads between 10% to 110% of design capacity.

75. The fuel processor of claim 74 comprising a dynamic fuel processor wherein load varying can be achieved by a simple ratio proportioning of the feed settings for the fuel, oxidant, and water to the fuel processor.

76. The fuel processor of claim 75 comprising a dynamic fuel processor wherein the technique of using the ratio proportioning of the feed settings provides a dynamic fast response to load changes while maintaining the fuel processor's performance characteristics.

77. The fuel processor of claim 1 wherein the WGS reactor, steam generator and PROX are disengaged, bypassed, or in a rest (non-operable) mode for molten carbonate and solid oxide fuel cell applications.

78. The fuel processor of claim 1 wherein the PROX is disengaged, bypassed, or in a rest (non-operable) mode for phosphoric acid fuel cell application.

79. The fuel processor of claim 1 comprising a dynamic fuel processor wherein the CO₂ in the PROX product gas is further removed for alkaline fuel cell application.

80. The fuel processor of claim 4 wherein the fuel, oxidant air and water supply tubes are provided with fail closed spring-loaded valves while a separate nitrogen flash tube is provided with a fail open spring loaded valve so that when power failure occurs, substantially all the supplies are automatically shut off, and the system is flushed with nitrogen for safety.

81. The fuel processor of claim 4 wherein the fuel and oxidant air supply tubes are provided with fail closed spring-loaded valves and a separate water supply is provided with a fail open spring loaded valve so that when power failure occurs, substantially all the supplies are automatically shut off, and the system is purged with steam.

82. A fuel processor for converting carbonaceous fuels into hydrogen rich gases for use with fuel cells and chemical processing applications, comprising:
a set of three cylinders positioned substantially concentrically to each other to define an autothermal hydrodesulfurizing reforming reaction zone, a sulfur reaction removal zone and a water gas shift (WGS) reaction zone;
said cylinders comprising an inner cylinder providing an autothermal hydrodesulfurizing reformer (AHR), an outer cylinder positioned outwardly of said inner cylinder, and an intermediate cylinder positioned between said inner cylinder and said outer cylinder;
said AHR comprising a dome defining a diffuser zone, a fuel tube in communication with said diffuser zone, a fuel injector for feeding carbonaceous fuel into said fuel tube, an oxygen-containing gas injector for feeding air or another oxygen-containing gas into said fuel tube along with said fuel, a water injector for feeding and mixing steam or water with said fuel and oxygen-containing gas in said fuel tube; and
an AHR catalyst positioned below said dome, said AHR catalyst comprising a dehydrogenation portion, an oxidation portion, and a hydrodesulfurizing portion.

83. A fuel processor in accordance with claim 82 comprising axial ends with insulating slabs.

84. A fuel processor in accordance with claim 82 including insulation separating said cylinders.

85. A fuel processor in accordance with claim 84 wherein said insulation is selected from the group consisting of zicar or air.

86. A fuel processor in accordance with claim 82 wherein said inner cylinder has a height extending substantially the height of said outer cylinder.

87. A fuel processor in accordance with claim 82 including a preheat coil for heating said air or oxygen-containing gas.

88. A fuel processor in accordance with claim 82 wherein said AHR comprises an air center tube and said catalyst is packed around said air center tube.

89. A fuel processor in accordance with claim 88 wherein said AHR comprises a bottom providing a perforated plate and said catalyst is positioned above said perforated plate.

90. A fuel processor in accordance with claim 88 wherein said AHR comprises bars to support and center said air center tube, and said bars are spaced from said inner cylinder to provide a clearance and passageway therebetween.

91. A fuel processor in accordance with claim 90 wherein said bars are secured to said dome.

92. A fuel processor in accordance with claim 88 wherein said air enter tube is axially aligned with said fuel tube.

93. A fuel processor in accordance with claim 88 wherein said air center tube is connected to said fuel tube and moves substantially vertically in unison with said fuel tube.

94. A fuel processor in accordance with claim 82 wherein said fuel processor comprises a multi-stage static mixer.

95. A fuel processor in accordance with claim 82 wherein said AHR catalyst comprises a sulfur tolerant catalyst suitable for partial oxidation, steam reforming, and downstream sulfur removal.

96. A fuel processor in accordance with claim 82 wherein said catalyst further comprises a coking-resistant catalyst.

97. A fuel processor in accordance with claim 82 wherein said catalyst of a monolith catalyst.

98. A fuel processor in accordance with claim 82 wherein:
said dehydrogenation portion comprises a metal and a metal alloy selected from the group consisting of Group VIII transition metals and mixtures thereof;
said oxidation portion comprises a ceramic oxide powder and a dopant selected from the group consisting of rare earth metals, alkaline earth metals, alkali metals and mixtures thereof; and
said hydrodesulfurization portion comprises a material selected from the group consisting of Group IV rare earth metal sulfides, Group IV rare earth metal sulfates, their substoichimetric metals and mixtures thereof.

99. A fuel processor in accordance with claim 98 wherein said ceramic oxide powder comprises a material selected from the group consisting of ZrO₂, CeO₂, Bi₂O₃, BiVO₄, LaGdO₃ and mixtures thereof.

100. A fuel processor in accordance with claim 82 comprising opposed annular jets for mixing feed streams and an air annulus tube positioned below said dome.

101. A fuel processor in accordance with claim 82 comprising a helical tube for passing superheated steam.

102. A fuel processor in accordance with claim 82 wherein said sulfur removal reaction zone contains a ZnO catalyst.

103. A fuel processor in accordance with claim 82 wherein said WGS reaction zone contains a WGS catalyst.

104. A fuel processor in accordance with claim 82 wherein said outer cylinder comprises a water jacket and inner fins for temperature control of reformate gas.

105. A fuel processor in accordance with claim 82 including an electric igniter for igniting the mixture of fuel, steam and said oxygen-containing gas.

106. A fuel processor in accordance with claim 82 comprising a multistage catalytic preferential oxidation (PROX) reactor.

107. A fuel processor for converting carbonaceous fuels into hydrogen rich gases for use with fuel cells and chemical processing applications, comprising:
a set of vessels having substantially upright concentric annular walls, said vessels comprising an inner vessel, an outer vessel, and an intermediate vessel positioned between said inner vessel and said outer vessel;
said inner vessel comprising an autothermal hydrodesulfurizing reformer (AHR) with an autothermal hydrodesulfurizing reforming reaction zone containing a bed of AHR catalyst, said AHR catalyst comprising a dehydrogenation portion, an oxidation portion, and a hydrodesulfurization portion, said inner vessel comprising a dome providing a diffuser zone positioned above said autothermal hydrodesulfurizing reforming reaction zone, a fuel tube in communication with said diffuser zone, and injectors for feeding a feed mixture of carbonaceous fuel, an oxidant, and water through said fuel tube into said diffuser zone, and said AHR catalyst reforming said feed mixture to form hydrogen-rich reformate gas in said autothermal hydrodesulfurizing reforming reaction zone;
an annulus comprising an intermediate annular vaporizer and preheater zone positioned between said inner vessel and said outer vessel and communicating with said autothermal hydrodesulfurizing reforming reaction zone for receiving and cooling said reformate gas from said autothermal hydrodesulfurizing reforming reaction zone, said intermediate annular vaporizer and preheater zone containing a preheat coil for receiving sensible heat form said reformats gas to heat at least some of said oxidant;
an annular sulfur removal zone positioned between said intermediate vessel and said outer vessel and communicating with said intermediate annular vaporizer and preheater zone for receiving said reformate gas from said intermediate annular vaporizer and preheater zone, said annular sulfur removal zone containing a bed of sulfur-removing catalyst for removing hydrogen sulfide from said reformate gas;
a water gas shaft (WGS) reactor comprising an outer annular WGS reaction zone positioned below and communicating with said annular sulfur removing zone located between said intermediate vessel and said outer vessel, said WGS reactor containing a bed of WGS catalyst for converting carbon monoxide to carbon dioxide and hydrogen from said reformate gas after said hydrogen sulfide has been removed from said reformate gas in said sulfur removal zone, said WGS reactor comprising a boiler coil for heating at least some of sad water; and
an outlet positioned below said inner vessel and said intermediate vessel and communicating with said WGS reaction zone for discharging said reformate gas after said carbon monoxide has been converted to carbon dioxide and hydrogen in said WGS reaction zone.

108. A fuel processor in accordance with claim 107 wherein said sulfur-removing catalyst comprises a zone oxide catalyst.

109. A fuel processor in accordance with claim 107 wherein said AHR comprises a velocity distributor element positioned between and communicating with said diffuser zone and said autothermal hydrodesulfurizing reforming reaction zone.

110. A fuel processor in accordance with claim 107 wherein said AHR provides a bottom comprising a perforated plate supporting said bed of AHR catalyst, said perforated plate separating said autothermal hydrodesulfurizing reforming reaction zone and said intermediate annular zone, and said perforated plate having openings for passage of said reformate gas from said autothermal hydrodesulfurizing reforming reaction zone to said intermediate annular zone.

111. A fuel processor in accordance with claim 107 wherein said fuel cells comprise polymer electrolyte membrane (PEM) fuel cells.

112. A fuel processor in accordance with claim 107 wherein:
said dehydrogenation portion comprises a metal and a metal alloy selected from the group consisting of Group VIII transition metals and mixtures thereof;
said oxidation portion comprises a ceramic oxide powder and a dopant selected from the group consisting of rare earth metals, alkaline earth metals, alkali metals and mixtures thereof; and
said hydrodesulfurization portion comprises a material selected from the group consisting of Group IV rare earth metal sulfides, Group IV rare earth metal sulfates, their substoichimetric metals and mixtures thereof.

113. A fuel processor in accordance with claim 112 wherein said ceramic oxide powder comprises a material from the group consisting of ZrO₂, CeO₂, Bi₂O₃, BiVO₄, LaGdO₃, and mixtures thereof.

114. A fuel processor in accordance with claim 107 wherein said chemical processing applications include chemical processors.
